(19) United States
(12) Patent Application Publication
(10) Pub. No.: US 2019/0110483 A1
(43) Pub. Date: Apr. 18, 2019

(54) PROCESS FOR PREPARING A CORN FLUOR-BASED PRODUCT PRESERVATIVE FREE IN A RETORTABLE PACKAGING AND RESULTING PRODUCT

(71) Applicant: Productos Verde Valle, S.A. de C.V., Zapopan (MX)

(72) Inventors: Jamne Alejandra PONCE SIMENTAL, Zapopan (MX); Elvia VILLARREAL FLORES, Zapopan (MX); Anton Leonard SCHORNO, Guadalajara (MX)

(73) Assignee: Productos Verde Valle, S.A. de C.V., Zapopan (MX)

(21) Appl. No.: 15/730,772

(22) Filed: Oct. 12, 2017

(51) Int. Cl. A21D 2/18; A21D 2/34; A21D 6/00

(52) U.S. Cl. CPC A21D 2/186; A21D 6/00; A21D 2/34

(57) ABSTRACT

A process for producing a corn flour-based food product preservative free in a retortable packaging, which comprises preparing a mixture of corn flour and a fatty component, and adding to said mixture a meat product or stew and other minor ingredients. The prepared mixture is added to a sterilizable pouch which is sealed and subjected to a sterilization process including a heating, sterilization or holding and a cooling stage, and under conditions of determined pressure and times.

### FIELD OF THE INVENTION

The invention relates to processes for preparing a food product based on nixtamalized corn flour, and more particularly to a process for preparing a food product in a sterilizable flexible packaging and the food product resulting from said process.

### BACKGROUND OF THE INVENTION

The prior art discloses a food composition for the production of flour by which it is possible to obtain, by adding a liquid, an instant mass for the manufacture of tamales directly and without adding any other ingredients, except for a filling. Also, said document relates to a method of obtaining said composition. The composition incorporates ingredients with functions of fats, without generating the problems of decomposition, bad smell or bad taste due to the presence of these compounds; it also contains a mixture of flours in which the flour both individually and the mixture itself has specific characteristics in terms of its composition and granulometry, which it defines as a relevant aspect of that proposal. Other ingredients forming part of the composition are leavening agents and sodium salts, among others.

However, the mentioned document does not anticipate a process of cooking and sterilizing of the product packaged in sterilizable pouches, nor describes the conditions of the process that make possible to obtain a product with flavor characteristics such as a homemade product.

On the other hand, it is known from the background of food products packaged in pouches or flexible bags, which are cooked and sterilized within the bag by a sterilization process involving the handling of certain special conditions of temperature and/or pressures, and times for obtaining a product with excellent sensorial characteristics and a long shelf life. Regarding this type of process, the Mexican patent 298533, which is owned by the same applicant, refers to a process of cooking beans to improve the taste and color during their preservation in sterilizable containers or pouches. This patent became the beginning in the way of making a food product based on that legume, packed in a pouch or sterilizable bag inside which the cooking process is completed and the final food product is sterilized. The similarity of the concept of said patent with which it is now proposed is only that both products are finally produced in a bag, however, both the stages of the process and its conditions, as well as the food composition used in each case, are different, which necessarily generates differences between the processes that are followed to elaborate the product.

In addition, the prior art shows which a process and a formulation are claimed for the production of a tubers-based food product, in which the similarity of the present innovation with that of the aforementioned patent application lies only in that both products are finally produced in a pouch or bag; however, both the process stages and their conditions, as well as the food composition used in each case, are different and this necessarily differentiates the stages of the process.

### SUMMARY OF THE INVENTION

A first object of the invention is to propose a process for making a corn fluor-based food product, which has sensory characteristics very similar to products made at home.

Another object of the invention is to propose a formulation suitable for elaborating the corn flour-based food product, the elaboration of which is subjected to sterilization process conditions, packaged in a pouch or flexible plastic pouch, and the final product has all the fresh, turgid and appetizing appearance of a freshly homemade meal.

Another object of the present invention is to propose a food product obtained by the formulation and the process forming part of this inventive concept.

In a preferred embodiment, the process for elaborating the corn flour-based food product, specifically for the manufacture of “tamales”, is characterized by the steps of:

hydration of the corn flour component up to 70% maximum, wherein a dye can be included or not at a sufficiently low temperature to avoid acidification of the resulting mass, which can contain from 10 to 30% of other starch components (starches of other grains or cereals);

aeration of the fatty component (vegetable or animal fat); preferably of the solid part when it is desired to obtain a finished product with a larger volume;

incorporation of the hydrated component of corn flour to the fatty component;

incorporation of minor solids as sweeteners, flavorings, colorings, fermenting agents among others;

incorporation of meat products;

mixing all major and minor ingredients with the object of allowing their incorporation;

determination of the density of the resulting mass;

packing a predetermined quantity of mass into sterilizable pouches and sealing them; and

sterilizing the packed product with the resulting mass to ensure the commercial sterility.

On the other hand, the corn flour-based product resulting from the above-described process is characterized by comprising: up to 40 or 50% maximum by weight of hydrated corn flour and; from 5 to 20% by weight of a fatty component and the rest consisting of minor ingredients such as flavorings, sweeteners, nuts, fruit jams, as well as meat or stews and fermenting agents or others, including agents having a technological function. The final product will have a moisture ranging between 40 and 70%.

### DETAILED DESCRIPTION OF THE PREFERRED EMBODIMENT OF THE INVENTION

The traditional way of making a tamale based on corn flour basically consists of a lime-cooked pasta mass and lightly seasoned with oil or lard, broth, and some other ingredient that can be salty (meat, stew) or sweet (fruits); all the above wrapped in leaves of plants, usually the same leaves of corn cob, but banana leaves can also be used; and steamed or in an oven.

This new process proposes the preparation of the tamale starting from corn flour, which is hydrated with water or some salty flavored broth in a proportion of 1:3 and mainly 1:2.5. Preferably, but not necessarily, the corn flour is nixtamalized.

Nixtamalization is a process including cooking the corn or maize in boiling water and lime to obtain “nixtamal”. Then, the nixtamal is grinded to produce nixtamalized corn flour, which is one of the main ingredients to elaborate tamales.

### Spongy Process

Additionally, the fatty component is agitated or blended to obtain a “snow dot” spongy texture by keeping the temperature below the melting temperature of the selected fatty component and preferably for the time necessary to achieve the desired density.

In an additional step after aeration of the fatty component, granular sweeteners or any other type of sweetener having physical characteristics similar to the fatty component are added and mixed in a proportion not greater than 8 to 25%. The mixing process of the fatty component and the minor ingredients may be made in a continuous manner so as to allow the controlled addition of the previously hydrated corn mass to create a “parent mass” to which, in a non-limited way, other ingredients such as spices or condiments, flavors, dried fruit or jellies or fruit jellies may be added and also agents with a technological function as releasers or precursors of carbon dioxide, preferably not exceeding 1%.

The process of incorporation and mixing of all major and minor ingredients takes place in a time no greater than 40 minutes and preferably less than 35 minutes.

On the other hand, the process described here proposes measuring the density of the mass once all the ingredients have been added to ensure the “home” texture of the finished product. Said density should range from 0.68 to 1.02 g/ml and preferably from 0.8 to 1.1 g/ml.

Also, the pH of the “parent mass” should preferably range from 5.5 to 7.3 to ensure low acidity conditions.

Once the density of the parent mass is obtained within the aforementioned ranges, the mass is introduced in a sterilizable flexible pouch, which is hermetically sealed to avoid contamination of the product and allows the cooking and sterilization of the food product within the same pouch, obtaining a product with a shelf life as long as 18 months without refrigeration and without the addition of preservatives.

Additionally, the present process proposes a sterilization treatment in a sterilizable flexible packaging comprising a heating, sterilization or holding stage and a cooling stage. The temperature during the sterilization or holding stage is maintained above 100° C. in order to decrease almost all microorganisms present in a food in such a way that the survival probability of a spore of a pathogen such as Clostridium Botolinum in a package is preferably 1×10⁻¹², at a temperature ranging from 110° C. to 125° C. for not more than 60 min and desirably not more than 55 min at a pressure below 3 bar and preferably less than 2.7 bar. It should be mentioned that said heat treatment conditions are proposed based on different factors such as:
Probability or presence of microorganisms present;
Properties and composition of the food product;
Initial temperature of the product;
pH of the product;
Initial microbial count or load;
Size/volume and nature of the container, among others.

If the temperature and correct times are not reached during the sterilization process, there is the possibility of germination and proliferation of Clostridium Botolinum spores, resulting in food poisoning.

Sterilization can be considered as a short-term process at high temperature, where both the pressure and the heat of compression and penetration, contribute to the lethality of the process.

The sterilization method enables inactivation of vegetative microorganisms by subjecting the food, previously packaged in sealed flexible containers, to the treatment under high pressure, at high temperatures and for several minutes, depending on the product in question. The use of low temperatures allows a better retention of the sensory attributes characterizing “fresh” or “freshly prepared” food, as well as the nutritional components of the food (Cano and de Ancos, 2005).

Unlike traditional pasteurization, sterilization allows the application of “instant” pressure in the fluids and semisolids inside the pressure vessel or recipient, thus achieving a reduction of the damage to the finished product. On the other hand, it can significantly increase the useful life of a product. In fact, this processing has the potential to offer products without chemical agents (preservatives) or additives, with minimal impact on shelf life, as the product object of this invention.

Like any other food preservation process, sterilization is specific to each product, so the extent of shelf life depends on the composition of the food, the presence and activity of enzymes, and the different species or bacterial strains present regularly within the food process.

Another use of sterilization is in modifying the texture of foods with high protein or starch content. Softened meats, dairy products or egg-based ingredients are some examples of the benefits observed in the modification of the texture as well as the case of the product proposed here because, without the thermal processing, the product is not considered suitable for its consumption both in the level of safety and in the sensorial characteristics, mainly the texture. Texture of foods composed of proteins and starches, as is the case here exposed, can be modified by applying heat due to the phenomena of gelatinization in the case of starch and the denaturation of proteins. The finished product of this invention shows a firm structure as well as a suitable bite resistance, which is a characteristic of homemade products.

Sterilization processing provides new opportunities for the food industry in the development of new products. It has a strong potential for the production of a wide range of high quality products, with a longer shelf life. Among these, prepared meats, fruits, vegetables, fresh herbs, and a great variety of products made with these ingredients, can be mentioned. Some of the products already marketed on the world market are fresh foods, such as new varieties of avocado products and juices; meat-based products; and different types of foods ready to eat (or heat and serve) as the case described here.

The quality, acceptability and nutritional value of non-perishable sterilized products depend not only on the developed food formulation, but also on the design of the process itself.

During the sterilization process the received amount of heat is determined by three main conditions: preheating/equilibrium temperature; the selected pressure; and the time of holding the pressure/temperature. In addition, there are other inherent factors such as the presence of low temperature sites in the vessel, initial pressure, maintenance of pressure, decompression speed, and properties of food and packaging material. All of these factors need to be considered when evaluating the performance of sterilization.

In an embodiment of a food product made from corn flour with sweet sensory characteristics, the fatty component is stirred or mixed until a spongy “snow dot” style texture is obtained by keeping the temperature below room temperature and preferably below the melting point of the selected fatty component.

On the other hand, in an embodiment of preparation of a corn flour-based food product having salty sensorial characteristics, the fatty component must be incorporated into the hydrated corn mass at a temperature below 70° C. and preferably greater than 50° C. Subsequently, once the mixture has been obtained, the minor ingredients and meat products should be incorporated into said mixture, if this is desired to obtain the parent mass.

### Exemplary Process.

According to a preferred embodiment of the invention, the novel process for making a corn flour-based food product is characterized by comprising the following steps:

hydrating the corn flour component by up to 70% maximum at a temperature low enough to avoid acidification of the resulting mass, wherein this latter may contain from 10 to 30% of other starch components;

stirring or mixing a fatty component to a spongy “snow dot” texture by keeping its temperature below room temperature and preferably below the melting point of the selected fatty component;

aerating the fatty component, preferably of the solid part when it is desired to obtain a finished product with a larger volume;

incorporating the hydrated component of corn flour into the fatty component; said fatty component is present in 5 to 20% of the total composition;

incorporating minor ingredients such as sweeteners, flavorings, colorants, fermenting agents, among others;

incorporating a meat product or stew and/or nuts or jellies, if desired;

mixing all major and minor ingredients with the object of allowing their incorporation;

determining the density of the resulting mass;

packaging a predetermined quantity of mass into flexible sterilizable pouches and sealing them; and

sterilizing the packaged product with the resultant mass at a temperature greater than 100° C., preferably at a temperature ranging from 110° C. to 125° C. for not more than 55 min and a pressure below 3 bar, preferably less than 2.7 bar.

It should be noted that the aeration step is optional in the process and is carried out if resulting products with higher volume are required.

### Exemplary Formulation.

According to a preferred embodiment of the invention, the composition prepared based on corn flour for making a food product is characterized in that it comprises:

up to 40 or 50% maximum by weight of hydrated nixtamalized corn flour;

from 5% to 20% by weight of a fatty component; and

the remainder comprising minor ingredients such as flavorings, sweeteners, nuts, fruit jams, as well as meat or stews and fermenting agents or others.

Although the invention (process and composition) has been described in the context of preferred embodiments, it will be apparent to those skilled in the art that the scope of the concept extends beyond the specifically described examples to other possible forms which are deductible from the contents of the foregoing description. In addition, although the invention has been described in detail, it will be understood by any skilled in the art to which the invention pertains that certain ingredients of the exemplified food composition may be substituted by different ones or similars. In the same sense, the percentages of each main, secondary or optional ingredient within the combination may well be different or fall outside the indicated ranges and thereby vary some of the process conditions described above for making the food product without departing from the inventive concept described above.

Therefore, it is intended that the scope of the invention protection is not interpreted in terms of the particularly described embodiments, but is determined by a reasonable interpretation of the content of the following claims.

It is pointed out that the best method of carrying out the present invention is that described hereinbefore.

What is claimed is:

1. A process for preparing a corn flour-based food product comprising the steps of:
hydrating a corn flour component by up to 70% maximum at a temperature low enough to avoid acidification of a resultant mass, wherein said mass contains from 10 to 30% of other starch components;
stirring or mixing a fatty component to obtain a spongy (snow do) texture by keeping its temperature below room temperature and preferably below a melting point of the fatty component;
incorporating the hydrated corn flour component into the fatty component; said fatty component is present in 5 to 20% of the total composition;
incorporating minor ingredients such as sweeteners, flavorings, colorants, fermenting agents, among others;
incorporating a meat product or stew, dried fruit, jams and jellies;
mixing all ingredients in order to allow their incorporation;
determining the density of a resultant mass;
packaging a predetermined quantity of the resultant mass into sterilizable pouches and sealing them;
sterilizing the packaged product with the resultant mass at a temperature above 100° C.

2. The process of claim 1, further comprising the step of aerating the fatty component prior to incorporating into the hydrated corn flour component, preferably the solid part, when it is desired to obtain a finished product with a larger volume.

3. The process of claim 1, wherein optionally a dye may be included in the resultant mixture.

4. The process of claim 1, wherein the sufficiently low temperature of the hydration step is below the room temperature, preferably below the melting point of the selected fatty component.

5. The process of claim 1, wherein the temperature of the fatty component is below 70° C., and preferably above 50° C.

6. The process of claim 1, wherein the sufficiently low temperature value in the hydration step directly depends on the selected fatty component.

7. The process of claim 1, wherein the corn flour is preferably nixtamalized.

8. The process of claim 1, wherein the density of the resultant mass should range from 0.68 to 1.02 g/ml and preferably from 0.8 to 1.1 g/ml.

9. The process of claim 1, wherein the pH of the parent mass preferably ranges from 5.5 to 7.3.

10. The process of claim 1, wherein the process of incorporating and mixing all major and minor ingredients should be carried out in a time period not longer than 40 minutes and preferably not exceeding 35 minutes.

11. The process of claim 1, wherein the final product has a moisture content of between 40 and 70%.

12. The process of claim 1, wherein the minor ingredients incorporated range from 8 to 25%.

13. The process of claim 1, wherein agents having a technological function, namely carbon dioxide releasers or precursors, are added in a percentage preferably not more than 1%.

14. The process of claim 1, wherein the starch components are selected on the basis of gelatinization and/or water absorption capacity.

15. The process of claim 1, which includes adding other ingredients such as spices or condiments, flavors, dried fruit or jellied fruit preparations or fruit jams, stews or meat products.

16. A composition based on a corn flour for making a food product comprising:
up to 40 or 50% by weight of hydrated corn flour;
from 5% to 20% by weight of a fatty component; and
at least one minor ingredients selected from the group consisting of flavorings, sweeteners, nuts, fruit jams, meat, stew, and fermenting agents.

17. The composition of claim 16, wherein the corn flour is nixtamalized.

18. A food product prepared from a nixtamalized corn flour by the process of claim 1.
